(19) United States
(12) Patent Application Publication
(10) Pub. No.: US 2022/0169875 A1
(43) Pub. Date: Jun. 2, 2022

(54) INK COMPOSITION FOR INK JET PIGMENT TEXTILE PRINTING, INK SET, AND RECORDING METHOD

(71) Applicant: Seiko Epson Corporation, Tokyo (JP)

(72) Inventor: Hiroaki MARUYAMA, Shiojiri (JP)

(21) Appl. No.: 17/456,227

(22) Filed: Nov. 23, 2021

(30) Foreign Application Priority Data
Nov. 27, 2020 (JP) 2020-197291

(51) Int. Cl. C09D 11/326; C09D 11/102; C09D 11/38; C09D 11/54; C08L 75/04; D06P 5/30

(52) U.S. Cl. CPC C09D 11/326; C09D 11/102; D06P 5/30; C09D 11/54; C08L 75/04; C09D 11/38

(57) ABSTRACT

An ink composition for ink jet pigment textile printing contains a dispersion of a self-dispersing carbon black pigment containing a phosphate group. An absolute value of a zeta potential V₁ of the dispersion is 65 mV or less.

The present application is based on, and claims priority from JP Application Serial Number 2020-197291, filed Nov. 27, 2020, the disclosure of which is hereby incorporated by reference herein in its entirety.

### BACKGROUND

### 1. Technical Field

The present disclosure relates to an ink composition for ink jet pigment textile printing, an ink set, and a recording method.

### 2. Related Art

An ink jet recording method can be used to record a high-definition image with a relatively simple device and has developed rapidly in various fields. In the meantime, various investigations have been made on image quality and the like. For example, JP-A-2004-123865 (hereinafter referred to as Patent Document 1) discloses an aqueous pigment ink containing pigment, an anionic dispersant, a cationic water-soluble polymeric compound, and an aqueous medium for the purpose of providing an aqueous pigment ink that enables recording of an excellent image.

According to Patent Document 1, it is disclosed that the pigment, which is a coloring component, is fixed to a surface portion of a recorded body without agglomerating on the surface portion of the recorded body because of the action of the cationic water-soluble polymeric compound, thereby enhancing the chroma and density of a print. However, on the other hand, the presence of a colorant on a surface layer of a record reduces the friction fastness. Therefore, there is a problem in ensuring both coloring properties and the friction fastness of the record.

### SUMMARY

An ink composition for ink jet pigment textile printing according to an aspect of the present disclosure contains a dispersion of a self-dispersing carbon black pigment containing a phosphate group. An absolute value of a zeta potential V₁ of the dispersion is 65 mV or less.

An ink set according to an aspect of the present disclosure contains the ink composition for ink jet pigment textile printing and a treatment solution composition. The treatment solution composition contains a cationic compound.

A recording method according to an aspect of the present disclosure includes a treatment solution application step of applying a treatment solution composition containing a cationic compound to fabric and an ink application step of applying the ink composition for ink jet pigment textile printing to the fabric by discharging the ink composition for ink jet pigment textile printing by an ink jet process.

### DESCRIPTION OF EXEMPLARY EMBODIMENTS

An embodiment (hereinafter referred to as “this embodiment”) of the present disclosure is described below in detail. The present disclosure is not limited to the embodiment. Various modifications can be made without departing from the scope of the present disclosure.

### 1. Ink Composition for Ink Jet Pigment Textile Printing

An ink composition for ink jet pigment textile printing (hereinafter simply referred to as the “ink composition”) of this embodiment contains a dispersion of a self-dispersing carbon black pigment containing a phosphate group. The absolute value of the zeta potential V₁ of the dispersion is 65 mV or less. The ink composition of this embodiment may contain resin particles, a water-soluble resin, a water-soluble organic solvent, water, a pH adjustor, a surfactant, and the like as required.

It is known to retain pigment near a surface layer of fabric using a treatment solution composition for the purpose of enhancing coloring properties. However, the pigment present on the surface layer of fabric is likely to fall. Therefore, there is a problem in that the dry friction fastness of a record that is obtained decreases. Furthermore, retaining pigment near a surface layer may possibly reduce the texture of a record that is obtained.

However, in this embodiment, the dispersibility of pigment is adjusted using a self-dispersing carbon black pigment having a predetermined zeta potential V₁ and a functional group, thereby allowing the pigment to remain on a surface layer of fabric to enhance coloring properties and enabling the dry friction fastness to be enhanced. Components of the ink composition of this embodiment are described below in detail.

### 1.1. Self-Dispersing Carbon Black Pigment

The ink composition of this embodiment contains a predetermined self-dispersing carbon black pigment. In this embodiment, the term “self-dispersing” refers to a property of something that can disperse by itself without the presence of a dispersant or the like. On the other hand, pigment that is dispersed with a resin dispersant is referred to as a resin-dispersed pigment.

The absolute value of the zeta potential V₁ of the dispersion of the self-dispersing carbon black pigment is 65 mV or less, is preferably 30 mV to 65 mV, is more preferably 40 mV to 65 mV, and is further more preferably 50 mV to 65 mV. The fact that the absolute value of the zeta potential V₁ is 65 mV or less slightly reduces the dispersion stability of the self-dispersing carbon black pigment; hence, dispersion destruction is more likely to occur on fabric. Therefore, before the self-dispersing carbon black pigment deeply permeates a recording medium, the self-dispersing carbon black pigment can remain on the recording medium, thereby enabling a record with high coloring properties to be obtained. The fact that the absolute value of the zeta potential V₁ is 30 mV or more tends to further enhance the self-dispersibility of the self-dispersing carbon black pigment. The zeta potential V₁ is preferably a negative value from the viewpoint of self-dispersibility.

A method for adjusting the zeta potential V₁ of the self-dispersing carbon black pigment is not particularly limited. The zeta potential V₁ of the self-dispersing carbon black pigment can be adjusted by, for example, the number of phosphate groups contained in the self-dispersing carbon black pigment or the like.

The zeta potential V₁ can be measured as follows: a sample is prepared in such a manner that a 15% dispersion of the self-dispersing carbon black pigment is diluted with water such that the concentration of solid matter is 0.0075 g/L (7.5 ppm), followed by measuring the sample by an electrophoretic light scattering method. Herein, the sample corresponds to a dispersion.

The self-dispersing carbon black pigment, which is used in this embodiment, contains the phosphate group and therefore has increased reactivity with a treatment solution composition below. Therefore, before the self-dispersing carbon black pigment deeply permeates a recording medium, the self-dispersing carbon black pigment is likely to be aggregated with the treatment solution composition on a surface of the recording medium, thereby enabling a record with high coloring properties to be obtained. In addition, since the self-dispersing carbon black pigment contains the phosphate group, the electrical adsorbability of the self-dispersing carbon black pigment on a record can be enhanced as compared to pigments containing a carboxy group or a sulfo group. Therefore, the dry friction fastness can also be further enhanced.

The content (solid matter) of the self-dispersing carbon black pigment is preferably 1.0% by mass to 12.5% by mass, more preferably 3.0% by mass to 10% by mass, and further more preferably 4.0% by mass to 7.5% by mass with respect to the total amount of the ink composition. The fact that the content of the self-dispersing carbon black pigment is within the above range tends to further enhance coloring properties of a record that is obtained.

### 1.2. Resin Particles

The resin particles are not particularly limited. Examples of the resin particles include urethane resin particles, acrylic resin particles, polyester resin particles, and polyethylene resin particles. Among these, the urethane resin particles are preferable. Using the resin particles tends to enhance the texture of a record that is obtained and the storage stability of the ink composition. The resin particles may be used alone or in combination of two or more thereof.

The urethane resin particles are not particularly limited and may be resin particles containing a urethane bond in a molecule. A polyether urethane resin containing an ether bond in a main chain, a polyester urethane resin containing an ester bond in a main chain, and a polycarbonate urethane resin containing a carbonate bond in a main chain are cited. Among these, the polyether urethane resin or the polycarbonate urethane resin is preferable and the polycarbonate urethane resin is more preferable. Anionic urethane resin particles containing a carboxy group, a sulfo group, a hydroxy group, or the like are preferable from the viewpoint of ensuring good dispersion stability.

The acrylic resin particles are not particularly limited. For example, one made by polymerizing a (meth)acrylic monomer such as (meth)acrylic acid or a (meth)acrylic ester and one made by copolymerizing such a (meth)acrylic monomer and another monomer are cited. In particular, anionic acrylic resin particles are preferable.

The urethane resin particles are not particularly limited. Examples of the urethane resin particles include non-crosslinkable urethane resin particles and crosslinkable urethane resin particles containing a crosslinkable group. Among these, the crosslinkable urethane resin particles are preferable. The crosslinkable group may be one that reacts with another crosslinkable group to form a crosslinking structure or one that reacts with a functional group different from the crosslinkable group to form a crosslinking structure. Using resin particles containing such a crosslinkable group tends to further enhance the texture and dry friction fastness of a record that is obtained and the storage stability of the ink composition.

The above crosslinkable group is not particularly limited and may be protected with, for example, a blocked isocyanate group, a silanol group, or a protective group. The silanol group is not particularly limited. Examples of the silanol group include a triethoxysilyl group, a trimethoxysilyl group, and a tris(2-methoxyethoxy)silyl group. The crosslinkable group is preferably the blocked isocyanate group from the viewpoint of storage stability and reactivity. The blocked isocyanate group is one formed by blocking an isocyanate group with a blocking agent.

The blocking agent blocks the isocyanate group to deactivate the isocyanate group and regenerates or activates the isocyanate group after deblocking. Examples of the blocking agent include imidazole compounds, imidazoline compounds, pyrimidine compounds, guanidine compounds, alcohol compounds, phenol compounds, activated methylene compounds, amine compounds, imine compounds, oxime compounds, carbamic acid compounds, urea compounds, acid amide (lactam) compounds, acid imide compounds, triazole compounds, pyrazole compounds, mercaptan compounds, and bisulfites. When resins contain a crosslinkable group, a crosslinking structure is formed, for example, between the resins, thereby allowing dry friction fastness to be good.

The content of the resin particles is preferably 2.0% by mass to 15% by mass, more preferably 3.0% by mass to 10% by mass, and further more preferably 5.0% by mass to 8.0% by mass with respect to the total amount of the ink composition. The fact that the content of the resin particles is 2.0% by mass or more tends to further enhance the dry friction fastness of a record that is obtained. The fact that the content of the resin particles is 10% by mass or less tends to further enhance the texture and dry friction fastness of a record that is obtained and the storage stability of the ink composition.

### 1.3. Water-Soluble Resin

The water-soluble resin is not particularly limited. Examples of the water-soluble resin include water-soluble acrylic resins, water-soluble styrene-acrylic resins, water-soluble styrene-maleic acid resins, water-soluble acrylonitrile-acrylic resins, water-soluble vinyl acetate-acrylic resins, water-soluble polyurethane resins, and water-soluble polyester resins. Among these, the water-soluble styrene-acrylic resins are preferable. Using the water-soluble resin tends to enhance the coloring and texture of a record that is obtained.

The content of the water-soluble resin is preferably 0.01% by mass to 1.0% by mass and more preferably 0.05% by mass to 0.5% by mass with respect to the total amount of the ink composition. The fact that the content of the water-soluble resin is within the above range tends to further enhance the coloring and texture of a record that is obtained.

### 1.4. Water-Soluble Organic Solvent

The water-soluble organic solvent is not particularly limited. Examples of the water-soluble organic solvent include glycols such as glycerin, ethylene glycol, diethylene glycol, triethylene glycol, propylene glycol, dipropylene glycol, 1,3-propanediol, 1,2-butanediol, 1,2-pentanediol, 1,2-hexanediol, 1,4-butanediol, 1,5-pentanediol, and 1,6-hexanediol; glycol monoethers such as ethylene glycol monomethyl ether, ethylene glycol monoethyl ether, diethylene glycol monomethyl ether, diethylene glycol monoethyl ether, propylene glycol monomethyl ether, propylene glycol monoethyl ether, dipropylene glycol monomethyl ether, dipropylene glycol monoethyl ether, and triethylene glycol monomethyl ether; nitrogen-containing solvents such as 2-pyrrolidone, N-methyl-2-pyrrolidone, and N-ethyl-2-pyrrolidone; and alcohols such as methanol, ethanol, n-propyl alcohol, isopropyl alcohol, n-butanol, 2-butanol, tert-butanol, isobutanol, n-pentanol, 2-pentanol, 3-pentanol, and tert-pentanol.

Among these, glycerin and the glycols are preferable and glycerin and triethylene glycol are more preferable. The water-soluble organic solvent may be used alone or in combination of two or more thereof.

The content of the water-soluble organic solvent is preferably 5.0% by mass to 30% by mass, more preferably 10% by mass to 25% by mass, and further more preferably 15% by mass to 20% by mass with respect to the total amount of the ink composition. The fact that the content of the water-soluble organic solvent is within the above range tends to further enhance the storage stability and mechanical stability.

### 1.5. Water

The content of the water is preferably 55% by mass to 85% by mass, more preferably 60% by mass to 80% by mass, and further more preferably 65% by mass to 75% by mass with respect to the total amount of the ink composition.

### 1.6. pH Adjustor

The pH adjustor is not particularly limited. Examples of the pH adjustor include inorganic acids (for example, sulfuric acid, hydrochloric acid, nitric acid, and the like), inorganic bases (for example, lithium hydroxide, sodium hydroxide, potassium hydroxide, ammonia, and the like), organic bases (triethanolamine, diethanolamine, monoethanolamine, and tripropanolamine), and organic acids (for example, adipic acid, citric acid, succinic acid, and the like). Containing the pH adjustor tends to further enhance the dispersion stability. The pH adjustor may be used alone or in combination of two or more thereof.

The content of the pH adjustor is preferably 0.01% by mass to 1.5% by mass, more preferably 0.05% by mass to 1.0% by mass, and further more preferably 0.1% by mass to 0.75% by mass with respect to the total amount of the ink composition. The fact that the content of the pH adjustor is within the above range tends to further enhance the dispersion stability.

### 1.7. Surfactant

The surfactant is not particularly limited. Examples of the surfactant include an acetylene glycol surfactant, a fluorinated surfactant, and a silicone surfactant.

The acetylene glycol surfactant is not particularly limited and is preferably one or more selected from the group consisting of, for example, 2,4,7,9-tetramethyl-5-decyne-4,7-diol, an alkylene oxide adduct of 2,4,7,9-tetramethyl-5-decyne-4,7-diol, 2,4-dimethyl-5-decyne-4-ol, and an alkylene oxide adduct of 2,4-dimethyl-5-decyne-4-ol.

The fluorinated surfactant is not particularly limited. Examples of the fluorinated surfactant include perfluoroalkyl sulfonates, perfluoroalkyl carboxylates, perfluoroalkyl phosphates, perfluoroalkyl ethylene oxide adducts, perfluoroalkyl betaines, and perfluoroalkylamine oxide compounds.

Examples of the silicone surfactant include polysiloxane compounds and polyether-modified organosiloxanes.

The hydrophile-lipophile balance (HLB) value of the surfactant is preferably 10 or more, more preferably 10 to 18, and further more preferably 12 to 16. The fact that the HLB value of the surfactant is within the above range tends to further enhance the storage stability and mechanical stability of the ink composition. In the present specification, the HLB value is defined by Griffin's method.

Among these, the acetylene glycol surfactant is preferable and an acetylene glycol surfactant with an HLB value of 10 or more is more preferable. Using the surfactant tends to enhance the storage stability and mechanical stability of the ink composition and to enhance coloring properties of a record that is obtained because the permeation of the surfactant into a recording medium can be suppressed.

The content of the surfactant is preferably 0.3% by mass to 2.5% by mass and more preferably 0.5% by mass to 2.0% by mass with respect to the total amount of the ink composition. The fact that the content of the surfactant is within the above range tends to further enhance coloring properties of a record that is obtained and the storage stability and mechanical stability of the ink composition.

The surfactant may be used alone or in combination of two or more thereof. The surfactant used may be, for example, a combination of an acetylene glycol surfactant with an HLB value of 10 or more and an acetylene glycol surfactant with an HLB value of less than 10. In this case, the content of the acetylene glycol surfactant with an HLB value of 10 or more is preferably 0.3% by mass to 1.5% by mass with respect to the total amount of the ink composition and the content of the acetylene glycol surfactant with an HLB value of less than 10 is preferably 0.1% by mass to 0.7% by mass with respect to the total amount of the ink composition. Using the surfactant tends to enhance the storage stability and mechanical stability of the ink composition and to enhance coloring properties of a record that is obtained because the permeation of the surfactant into a recording medium can be suppressed.

### 2. Ink Set

An ink set according to this embodiment contains the ink composition for ink jet pigment textile printing and a treatment solution composition. The treatment solution composition contains a cationic compound.

### 2.1. Treatment Solution Composition

The treatment solution composition contains a cationic compound and may further contain water or a fixing agent as required.

### 2.1.1. Cationic Compound

The cationic compound is not particularly limited. Examples of the cationic compound include a polyvalent metal salt, a cationic resin, and a cationic surfactant. Among these, the polyvalent metal salt is preferable. Using the cationic compound tends to enhance coloring properties of a record that is obtained.

The polyvalent metal salt is not particularly limited and is, for example, a polyvalent metal salt of an inorganic acid or a polyvalent metal salt of an organic acid. A polyvalent metal is not particularly limited. Examples of the polyvalent metal include alkaline-earth metals (for example, magnesium and calcium) of group 2 of the periodic table, transition metals (for example, lanthanum) of group 3 of the periodic table, earth metals (for example, aluminium) of group 13 of the periodic table, and lanthanides (for example, neodymium). Salts of these polyvalent metals are preferably carboxylates (formates, acetates, benzoates, and the like), sulfates, nitrates, chlorides, and thiocyanates.

In particular, calcium or magnesium carboxylates (formates, acetates, benzoates, and the like), calcium or magnesium sulfate, calcium or magnesium nitrate, calcium chloride, magnesium chloride, and calcium or magnesium thiocyanate are cited. The polyvalent metal salt may be used alone or in combination of two or more thereof.

The cationic resin is not particularly limited. Examples of the cationic resin include amine resins such as polyallylamine, poly(vinylpyridine) salts, polyalkylaminoethyl acrylates, polyalkylaminoethyl methacrylates, poly(vinylimidazole), poly(glucosamine), polyethyleneimine, polybiguanide, polyhexamethyleneguanide, and polyguanide.

The cationic surfactant is not particularly limited. Examples of the cationic surfactant include primary amine salt compounds, secondary amine salt compounds, tertiary amine salt compounds, alkylamine salts, dialkylamine salts, aliphatic amine salts, benzalkonium salts, quaternary ammonium salts, quaternary alkylammonium salts, alkylpyridinium salts, imidazolinium salts, sulfonium salts, phosphonium salts, and onium salts.

The content of the cationic compound is preferably 0.1% by mass to 5.0% by mass, more preferably 0.3% by mass to 2.5% by mass, and further more preferably 0.3% by mass to 1.0% by mass with respect to the total amount of the treatment solution composition. The fact that the content of the cationic compound is 0.1% by mass or more tends to further enhance coloring properties and the dry friction fastness of a record that is obtained. The fact that the content of the cationic compound is 5.0% by mass or less tends to further enhance the texture of a record that is obtained.

### 2.1.2. Water

The content of water is preferably 90% by mass to 99% by mass, more preferably 93% by mass to 99% by mass, and further more preferably 95% by mass to 99% by mass with respect to the total amount of the treatment solution composition.

### 2.1.3. Fixing Agent

The fixing agent is not particularly limited and is, for example, an epichlorohydrin polycondensate. A compound containing a plurality of glycidyl ether groups, a compound containing a plurality of oxazoline groups, and a compound containing a plurality of terminal blocked isocyanate groups can be cited. An epoxy resin having a glycidyl ether skeleton is cited as a compound containing a glycidyl ether group. A resin containing an oxazoline group is cited as a compound containing an oxazoline group. A urethane resin containing a terminal blocked isocyanate group is cited as a compound containing a terminal blocked isocyanate group. Examples of commercially available products of these include ELASTRON BN-69, BN-77, BN-27, BN-11, BNP17, BN-P18 (trade names, produced by Dai-ichi Kogyo Seiyaku Co., Ltd., aqueous urethane resins). Using the fixing agent tends to further enhance the dry friction fastness of a record that is obtained.

The content of the fixing agent is preferably 0.1% by mass to 3.0% by mass, more preferably 0.5% by mass to 2.5% by mass, and further more preferably 1.0% by mass to 2.0% by mass with respect to the total amount of the treatment solution composition. The fact that the content of the fixing agent is within the above range tends to further enhance the dry friction fastness of a record that is obtained.

### 2.1.4. Zeta Potential V₂

The absolute value of the zeta potential V₂ of the treatment solution composition is preferably 0 mV to 80 mV. The fact that the absolute value of the zeta potential V₂ of the treatment solution composition is within the above range tends to further enhance the dry friction fastness and coloring properties of a record that is obtained. The zeta potential V₂ is preferably a positive value.

The absolute value |V₁−V₂| of the difference between the zeta potential V₁ of the self-dispersing carbon black pigment in the ink composition and the zeta potential V₂ of the treatment solution composition is preferably 65 mV or more. The fact that the absolute value |V₁−V₂| is within the above range tends to further enhance the dry friction fastness and coloring properties of a record that is obtained.

### 3. Recording Method

A recording method of this embodiment includes a treatment solution application step of applying a treatment solution composition containing a cationic compound to fabric and an ink application step of applying the ink composition for ink jet pigment textile printing to the fabric by discharging the ink composition for ink jet pigment textile printing by an ink jet process.

### 3.1. Treatment Solution Application Step

The treatment solution application step is a step of applying the treatment solution composition, which contains the cationic compound that aggregates a component of the ink composition. In this step, a region coated with the treatment solution composition and a region coated with the ink composition are arranged to at least partly overlap each other. The fact that the recording method includes the treatment solution application step allows a component of the ink composition to be aggregated on a surface of a recording medium and tends to further enhance coloring properties and the dry friction fastness of a record that is obtained.

A method for applying a treatment solution may be a method in which the treatment solution is applied using an ink jet system or a method in which the treatment solution is applied using a bar coater, a roll coater, a spray, or the like.

The treatment solution application step may be performed before or after the ink application step, which is described below. When the treatment solution application step is performed before the ink application step, the ink application step may be performed before or after the treatment solution is dried.

### 3.2. Ink Application Step

The ink application step is a step of applying the ink composition for ink jet pigment textile printing to the fabric by discharging the ink composition for ink jet pigment textile printing by the ink jet process.

Herein, an ink jet head is a head that discharges the ink composition toward the fabric to perform recording. The head includes a cavity that discharges the stored ink composition from a nozzle, a discharge drive section that applies discharge driving force to the ink composition, and a nozzle that discharges the ink composition outside the head. The discharge drive section can be formed using an electromechanical conversion element such as a piezoelectric element that varies the volume of a cavity by mechanical deformation or an electrothermal conversion element that generates bubbles in ink by generating heat to discharge the ink.

### 3.3. Another Step

The recording method of this embodiment may further include a heating step of heating the fabric after the treatment solution application step and the ink application step as another step. Heating tends to further enhance the abrasion resistance of a record that is obtained.

### 3.4. Fabric

Fiber forming the fabric is not particularly limited. For example, natural fibers such as silk, cotton, and wool or synthetic fibers such as nylon, polyester, and rayon are cited.

### EXAMPLES

The present disclosure is further described below in detail with reference to examples and comparative examples. The present disclosure is not in any way limited to the examples.

### 1. Preparation of Ink Composition

Components were put into a mixture tank so as to give a composition shown in Table 1, followed by mixing, stirring, and filtration with a 5 μm membrane filter, whereby an ink composition of each example was obtained. Incidentally, the values of components shown in each example in Table 1 are in mass percent unless otherwise specified.

Abbreviations and components of products used in Table 1 are as described below.

### Pigment Dispersion

Self-Dispersing Pigment A (produced by Cabot Corporation, CAB-O-JET400K, a zeta potential of −63.4 mV, a self-dispersing carbon black pigment containing a phosphate group, a solid content of 15 wt %)
Self-Dispersing Pigment B (produced by Orient Chemical Industries Co., Ltd., CW-E55, a zeta potential of −68.1 mV, a self-dispersing carbon black pigment containing a carboxy group, a solid content of 15 wt %)
Resin-dispersed pigment (produced by Cabot Corporation, CAB-O-JET800K, a solid content of 15 wt %) Resin Particles
Resin Particles A (produced by Mitsui Chemicals, Inc., Takelac W6010, a non-crosslinkable resin, no blocking agent contained, a 100% modulus of 14, an elongation of 380, a Tg of 90° C., a solid content of 30 wt %)
Resin Particles B (produced by Mitsui Chemicals, Inc., Takelac W6021, a crosslinkable resin, a blocking agent contained, a 100% modulus of 3, an elongation of 750, a Tg of 40° C., a solid content of 30 wt %)

### Water-Soluble Resin

Styrene-maleic acid resin (produced by Arakawa Chemical Industries, Ltd., a styrene-maleic acid resin half ester) Water-Soluble Organic Solvent
Glycerin
TEG (triethylene glycol)

### pH Adjustor

TEA (triethylamine)

### Surfactant

Olfine E1010 (produced by Nissin Chemical Industry Co., Ltd., an acetylenic surfactant, an HLB value of 13 to 14)
Olfine 10PG (produced by Nissin Chemical Industry Co., Ltd., an acetylenic surfactant, an HLB value of 4)
BYK-348 (produced by BYK Japan KK, a silicone surfactant)

### 1.1. Measurement of Zeta Potential V₁

A 15% dispersion of a self-dispersing carbon black pigment was diluted with water such that the concentration of solid matter was 0.0075 g/L (7.5 ppm), whereby a measurement sample was prepared. The zeta potential V₁ was measured with a zeta potential analyzer (Zetasizer Nano ZS) by an electrophoretic light scattering method using the measurement sample that was obtained. Measurement was performed three times and the average was obtained as the zeta potential V₁.

### 2. Preparation of Treatment Solution

Water was mixed with 0.3% by mass of magnesium chloride as a flocculating agent and 1.5% by mass of an epichlorohydrin polycondensate as a fixing agent, followed by filtration with a 5 μm membrane filter, whereby a treatment solution of each example was obtained.

### 2.1. Measurement of Zeta Potential

The zeta potential V₂ of a treatment solution was measured with a zeta potential analyzer (Zetasizer Nano ZS) using a measurement sample that was obtained in such a manner that the treatment solution was diluted with water such that the concentration of solid matter was 7.5 ppm.

### 3. Evaluation

### 3.1. Storage Stability

After each ink composition prepared as described above was poured into a 50 cc glass bottle and the glass bottle was hermetically sealed, the glass bottle was put in a 60° C. thermostatic chamber. After the glass bottle was left therein for seven days, the glass bottle was taken out and was sufficiently cooled to room temperature, and the ink composition was then measured for viscosity in accordance with JIS Z 8809 using a vibrational viscometer. The rate of increase in viscosity after leaving for seven days with respect to the initial viscosity before leaving was calculated, followed by evaluating the storage stability in accordance with evaluation criteria below.

### Evaluation Criteria

A: The rate of increase in viscosity of an ink composition is less than 3%.
B: The rate of increase in viscosity of an ink composition is 3% or more.

### 3.2. Mechanical Stability

A cartridge of an ink jet printer, PX-G930 (manufactured by Seiko Epson Corporation), was filled with the above ink composition. After filling, no filling failure or nozzle clogging by printing a nozzle check pattern was confirmed and the printer was then left at 25° C. or 40° C. for three months with a head returned to a home position (that is, with a head nozzle surface head-capped). Thereafter, the head was removed from the printer and the condition of the tip of the nozzle was visually observed. In this observation, a foreign substance was evaluated in accordance with evaluation criteria below.

### Evaluation Criteria

A: The occurrence of a foreign substance was not observed.
B: Although a nozzle was clogged by the occurrence of a foreign substance, the nozzle could be returned to an actually usable state by maintenance such as cleaning.
C: A nozzle was clogged by the occurrence of a foreign substance and could not be returned to an actually usable state even by performing maintenance such as cleaning.

### 3.3. Dry Friction Fastness

A pattern was printed on fabric (Printstar Heavy Weight (white) 5.6 oz) at a resolution of 1,440 dpi×1,440 dpi in an application quantity of 200 mg/inch² using a printer (SC-F200) manufactured by Seiko Epson Corporation and each textile printing ink composition. After printing, a textile print was fixed by heat treatment at 165° C. for five minutes in a conveyor oven (a hot-air drying method) again.

The obtained textile print was subjected to a colorfast test for dry friction in accordance with regulations in ISO-105 X12 using a I-type (clock meter) testing machine. Evaluation criteria were as described below.

### Evaluation Criteria

A: Grade 2-3 or more
B: Lower than Grade 2-3, Grade 2 or more
C: Lower than Grade 2

### 3.4. Coloring Properties

The OD value of a printed portion of a textile print prepared in Dry Friction Fastness above was measured with a colorimeter (trade name “Gretag Macbeth Spectrolino”, manufactured by X-Rite Inc.) and coloring properties were evaluated based on the obtained OD value in accordance with evaluation criteria below. Evaluation criteria
S: An OD value of 1.65 or more
A: An OD value of 1.6 or more and less than 1.65
B: An OD value of 1.55 or more and less than 1.6
C: An OD value of 1.5 or more and less than 1.55
D: An OD value of less than 1.5

### 3.5. Texture

A printed portion of a textile print prepared in Dry Friction Fastness above was directly touched with a palm and the touch of the printed portion was determined in accordance with evaluation criteria below. Decision was made by three people and the most supported opinion was taken as a result of the decision. When the decision differed for each person, an opinion therebetween was taken as a result of the decision.

### Evaluation Criteria

A: The hardness and touch of a printed portion are almost the same as those of original fabric and are good.
B: The hardness or touch of a printed portion slightly differs from that of original fabric and is satisfactory for practical use.
C: The hardness or touch of a printed portion is poorer than that of original fabric and is allowable.

TABLE 1

| | | Examples | | | | | | | | | Comparative Examples | | |
|---|---|---|---|---|---|---|---|---|---|---|---|---|---|
| | | 1 | 2 | 3 | 4 | 5 | 6 | 7 | 8 | 9 | 1 | 2 | 3 |
| Pigment | Self-Dispersing | 5.0 | 5.0 | 5.0 | 5.0 | 5.0 | 5.0 | 5.0 | 5.0 | 5.0 | — | — | — |
| | Pigment A | | | | | | | | | | | | |
| | Self-Dispersing | — | — | — | — | — | — | — | — | — | 5.0 | 5.0 | — |
| | Pigment B | | | | | | | | | | | | |
| | Resin-dispersed | — | — | — | — | — | — | — | — | — | — | — | 5.0 |
| | pigment | | | | | | | | | | | | |
| Resin | Resin Particles A | 7.0 | 7.0 | 7.0 | 6.0 | — | — | — | — | — | — | 6.0 | 6.0 |
| particles | Resin Particles B | — | — | — | — | 6.0 | 7.0 | 6.0 | 6.0 | 6.0 | 6.0 | — | — |
| Water- | Styrene-maleic | — | — | — | — | — | — | 0.1 | — | — | — | — | — |
| soluble | acid resin | | | | | | | | | | | | |
| resin | | | | | | | | | | | | | |
| Water- | Glycerin | 14.0 | 14.0 | 14.0 | 14.0 | 14.0 | 14.0 | 14.0 | 14.0 | 14.0 | 14.0 | 14.0 | 14.0 |
| soluble | TEG | 3.0 | 3.0 | 3.0 | 3.0 | 3.0 | 3.0 | 3.0 | 3.0 | 3.0 | 3.0 | 3.0 | 3.0 |
| organic | | | | | | | | | | | | | |
| solvent | | | | | | | | | | | | | |
| pH adjustor | TEA | 0.5 | 0.5 | 0.5 | 0.5 | 0.5 | 0.5 | 0.5 | 0.5 | 0.5 | 0.5 | 0.5 | 0.5 |
| Surfactant | Olfine E1010 | 1.0 | 0.5 | — | 0.5 | 0.5 | 0.5 | 0.5 | 0.5 | 0.5 | 0.5 | 0.5 | 0.5 |
| | Olfine 10PG | 0.6 | 0.3 | — | 0.3 | 0.3 | 0.3 | 0.3 | 0.3 | 0.3 | 0.3 | 0.3 | 0.3 |
| | BYK-348 | — | — | 1.0 | — | — | — | — | — | — | — | — | — |
| Water | | Balance | Balance | Balance | Balance | Balance | Balance | Balance | Balance | Balance | Balance | Balance | Balance |
| Evaluation | Storage stability | A | B | B | A | B | B | B | — | — | A | A | A |
| results | Mechanical stability | A | B | B | B | A | A | B | — | — | A | A | A |
| | Dry friction fastness | A | A | A | B | A | A | B | A | A | B | B | C |
| | Coloring properties | A | A | B | A | B | B | S | A | A | C | D | D |
| | Texture | A | A | A | A | B | C | A | A | B | B | B | C |

### 4. Evaluation Results

Evaluation results of examples and comparative examples were shown in Table 1. As is clear from Table 1, using a predetermined self-dispersing carbon black pigment enhances coloring properties of a record that is obtained and further enhances the dry friction fastness.

What is claimed is:

1. An ink composition for ink jet pigment textile printing containing a dispersion of a self-dispersing carbon black pigment containing a phosphate group,
wherein an absolute value of a zeta potential V₁ of the dispersion is 65 mV or less.

2. The ink composition for ink jet pigment textile printing according to claim 1, further containing urethane resin particles.

3. The ink composition for ink jet pigment textile printing according to claim 2, wherein the urethane resin particles are non-crosslinkable urethane resin particles.

4. The ink composition for ink jet pigment textile printing according to claim 1, further containing an acetylene glycol surfactant with an HLB value of 10 or more.

5. An ink set containing:
the ink composition for ink jet pigment textile printing according to claim 1; and
a treatment solution composition,
wherein the treatment solution composition contains a cationic compound.

6. The ink set according to claim 5, wherein the cationic compound is one or more selected from the group consisting of polyvalent metal salts, cationic resins, and cationic surfactants.

7. A recording method comprising:
a treatment solution application step of applying a treatment solution composition containing a cationic compound to fabric; and
an ink application step of applying the ink composition for ink jet pigment textile printing according to claim 1 to the fabric by discharging the ink composition for ink jet pigment textile printing by an ink jet process.
